(19) United States
(12) Patent Application Publication
(10) Pub. No.: US 2002/0147834 A1
(43) Pub. Date: Oct. 10, 2002

(54) Streaming videos over connections with narrow bandwidth

(76) Inventors: Shih-Ping Liou, West Windsor, NJ (US); Ruediger Schollmeier, Gauting (DE); Killian Heckrodt, Princeton, NJ (US)

Correspondence Address: Siemens Corporation, Intellectual Property Department, 186 Wood Avenue South, Iselin, NJ, 08830, US

(21) Appl. No.: 10/023,532

(22) Filed: Dec. 18, 2001

Related U.S. Application Data
(60) Provisional application No. 60/256,651, filed on Dec. 19, 2000.

(51) Int. Cl. G06F 15/16

(52) U.S. Cl. 709/236

(57) ABSTRACT

A method for frame streaming using intelligent frame selection comprises ranking a plurality of frames according to a plurality of priorities. The method further comprises selecting, during a run-time, a frame for transmission over a network to a receiving client, wherein selecting the frame comprises determining a time of transmission, wherein the time of transmission is the time the frame will take to reach the receiving client. Selecting further comprises determining the frame's rank, determining a bandwidth over the network, and determining a current time.

This application claims the benefit of U.S. Provisional Application No. 60/256.651, filed Dec. 19, 2000.

### BACKGROUND OF THE INVENTION

1. Field of the Invention

The present invention relates to data streaming, and more particularly to video streaming over low bitrate wireless networks.

2. Discussion of Related Art

To support the streaming of video over low-bitrate (20 kbps-100 kbps) and lossy wireless networks, a system needs to automatically adapt the video to a format suitable for rendering. This can involve reduction of spatial resolution, reduction of signal to noise ratio (SNR), and reduction of frame rate. From a viewer's perspective, reduction of frame rate provides the best results regarding the viewer's comprehension of the video. Severe degradation in spatial resolution or SNR can result in frames that are either too small or too blurred for a viewer to perceive enough details, and even worse, can distract viewers' attention and harm the comprehension of the video.

A number of mechanisms, such as H.263, MPEG-4 and Temporal Subband Coding, have been proposed to provide temporal scalability for streaming video applications over low bitrate and lossy networks. Unfortunately, these depend on rigid coding structures. Thus, adapting these methods can be difficult. In addition, frames may be dropped without taking into account semantics information of individual frame, e.g., the selection of frames in the MPEG-4 base layer or enhance layers is based on the position in the video stream rather than the importance in semantics.

Therefore, a need exists for a content-sensitive video streaming system and method over low bitrate and lossy wireless networks.

### SUMMARY OF THE INVENTION

According to an embodiment of the present invention, a method is provided for frame streaming using intelligent frame selection. The method comprises ranking a plurality of frames according to a plurality of priorities. The method further comprises selecting, during a run-time, a frame for transmission over a network to a receiving client, wherein selecting the frame comprises determining a time of transmission, wherein the time of transmission is the time the frame will take to reach the receiving client.

The method comprises determining a priority one frame according to a position in the video, and determining a priority two frame according to dynamic information in the video. Dynamic information comprises one of visual effects, camera motion, and object motion.

Selecting further comprises determining the frame's rank, determining a bandwidth over the network, and determining a current time.

Frames are ranked according to semantic information. Semantic information is determined according to a table of contents.

The method comprises determining a round-trip-time. The receiving client and a sending client exchange packets comprising a timestamp. The method further comprises determining a time-to-send according to a perceived bandwidth of the network. The frame comprises a timestamp.

According to another embodiment of the present invention, a method is provided for frame streaming using intelligent frame selection. The method comprises determining whether a first frame is in a queue, determining a first priority of the first frame, and determining whether the first frame can be transmitted to a client. The method further comprises determining whether a next frame of the first priority, whose timestamp is greater than a currently considered frame of a second priority, can arrive at the client after the currently considered frame of the second priority is sent. Upon determining that the next frame can arrive, the method sends the first frame.

Determining whether the first frame can be transmitted depends on a timestamp of the first frame, an expected available bandwidth and a current time.

The method comprises determining, recursively, whether each frame of the second priority can be transmitted to the client, until frames of the first priority are sent according to timestamps, or no frames of the second priority with timestamps smaller than the timestamp of the next frame of the first priority are in the queue.

Within the queue, frames are sorted according to timestamps. The top frame of a queue is that frame, which has currently the lowest timestamp, compared to the other frames in the queue.

According to another embodiment of the present invention, a method is provided for frame streaming using intelligent frame selection. The method comprises sorting a plurality of frames, according to timestamps, within a queue, wherein frames have one of two or more priorities. The method further comprises determining whether the top frame of the queue is to be sent to a client according to a latest start time of the frame.

The top frame of the queue is that frame, which has currently the lowest timestamp, compared to all the other frames that are still in the queue.

The method adjusts, recursively, a value of a latest start time to the next first priority frame, such that all N−1 following first priority frames arrive at the client.

Determining whether the top frame is to be sent further comprises determining a duration of transmission of the frame. Determining whether the top frame is to be sent further comprises the step of considering each next frame of a higher priority.

According to an embodiment of the present invention, a method is provided for selecting a ranked frame from a plurality of ranked frames to send to a client. The method comprises determining a rank for a frame of in a queue of frames, processing the frame according to its rank and a latest start time of a next frame.

Processing the frame further comprises determining whether the frame can arrive at a client in time, depending on a frame timestamp, an expected available bandwidth and a current time, and determining whether a next higher priority frame can arrive at the client in time, if the frame is sent to the client.

Determining whether the next higher priority frame can arrive at the client in time is repeated from each queue of frames having a higher priority than the frame.

According to an embodiment of the present invention, a system is provided for content streaming using intelligent frame selection. The system comprises an automatic content analysis module for selecting a key-frame and ranking the key-frame according to a plurality of priorities. The system further comprises a streaming server for selecting a frame during a run-time to send to a client according to a time of transmission, wherein the time of transmission is the time the frame will take to reach the receiving client.

The streaming server comprises a sorting module for sorting a plurality of frames, according to timestamps, within a queue, wherein frames have one of three or more priorities, and a sending module for determining whether the top frame is to be sent to a client according to a latest start time of the frame.

The system comprises a streaming server, wherein the streaming server comprises a controller for maintaining a control link to a client player via which the player can send request and statistics information. The streaming server further comprises a server for delivering time-stamped frames, and a video server for delivering an audio track.

The controller selects a server to transmit frames and controls the servers providing the frames.

The system comprises a client player, wherein the client player comprises a client controller accepts input commands and translates the commands into requests, and at least one player for play back of streaming content.

The client controller collects network connection and playback performance statistical information. The client controller maintains a control connection to a server controller through which requests and statistic information are sent. The client player further comprises an audio/visual module for displaying content.

### BRIEF DESCRIPTION OF THE DRAWINGS

Preferred embodiments of the present invention will be described below in more detail, with reference to the accompanying drawings:

FIG. 1 is an overview of a content-sensitive video stream system, according to an embodiment of the present invention;

FIG. 2 is a diagram of a streaming protocol architecture, according to an embodiment of the present invention;

FIGS. 3a and 3b are diagrams of packet formats, according to an embodiment of the present invention;

FIG. 4a depicts a method for sending frames, according to an embodiment of the present invention;

FIG. 4b depicts a method for sending frames with more than two priorities, according to an embodiment of the present invention;

FIG. 4c depicts sub-methods of FIG. 4b, according to an embodiment of the present invention;

FIG. 4d shows a method for determining a latest start time of a next priority one frame, according to an embodiment of the present invention;

FIG. 5 is a diagram of a server-side system, according to an embodiment of the present invention;

FIG. 6 is a diagram of a client-side system, according to an embodiment of the present invention;

FIG. 7a is a table of frames for streaming, according to an embodiment of the present invention; and

FIG. 7b is an illustrative example of frames on a timeline according to FIG. 7a.

### DETAILED DESCRIPTION OF PREFERRED EMBODIMENTS

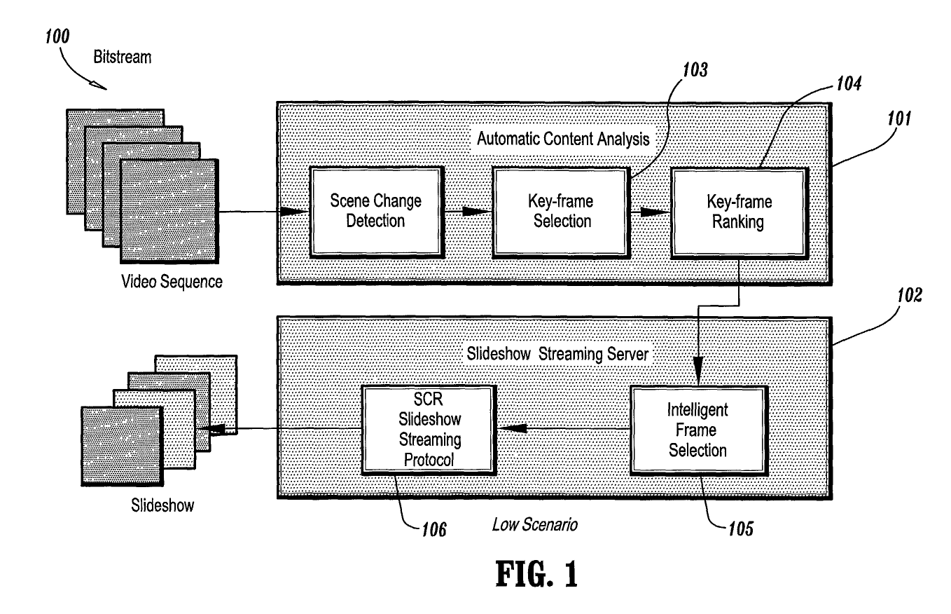

According to an embodiment of the present invention, a system and method for video streaming over low-bitrate and lossy wireless networks is provided, which uses content processing results to provide temporal scalability. An outline of a method for streaming video is presented in FIG. 1.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Referring to FIG. 1, a system according to an embodiment of the present invention can be considered as two subsystems. An automatic content analysis subsystem 101 extracts key-frames and ranks them according to the semantics of the video, whereas a content-sensitive streaming server 102 including a frame selection module 105 and a streaming protocol module 106. The frame selection module 105 intelligently selects key-frames to be sent, based on their ranks and the current network characteristics, and delivers them to the client player in an efficient, adaptive, and reliable manner.

An important objective of the automatic content analysis subsystem 101 is to extract key-frames and rank them from a video. When semantic information is directly available, key-frames can be ranked very easily. For example, the beginning frame of a story will be ranked with priority one, followed by the beginning frame of a sub-story, the beginning frame of a shot, and significant frames of each shot based on motion and color activity. When semantic information is not directly available, the system recovers the shots present in a video in a key-frame selection module 103. Semantic information can be determined or discovered according to, for example, a table of contents. A shot refers to a contiguous recording of one or more frames depicting a continuous action in time and space. For most videos, shot changes or cuts are created intentionally by video/film directors and therefore represent an important change of semantics. Frames are ranked by a key-frame ranking module 104. The automatic content analysis system 101 automatically detects cuts and selects the first frame in each shot as a key-frame with priority one ranking.

Once cuts are detected, a key-frame selection module 103 and a key-frame ranking module 104 analyzes the frames within a shot to locate those frames that represent dynamic information contained in a shot according to visual effects and camera and/or object motion. While preserving as much of the visual content and temporal dynamics in the shot as possible, the system minimizes the number of representative frames needed for an efficient visual summary. Such representative frames are key-frames with priority two ranking. Remaining frames in each shot are key-frames with priority three ranking.

The representative frames of each shot are selected by analyzing the motion and color activity. Depending on the computational power, the system can determine an average pixel-based absolute frame difference between consecutive frames, the camera motion between consecutive frames, the color histogram of each frame within the shot, or a combination of these. Motion estimation needs the largest computation power, then the histogram computation, and finally the frame difference computation.

Let n and m denote the starting frame index of the consecutive shots. The system obtains the temporal activity curves, CFD[i], HA[i], and MA[i], for i=n+1,. . . ,m−1 based on frame differences, color histograms and camera motions within the shot, respectively. The cumulative frame difference curve CFD[i] is computed as:

$$C F D [ i ] = {\sum }_{k = n + 1}^{i} \frac{1}{T} {\sum }_{( x , y )} \vert {f}_{k} ( x , y ) - {f}_{k - 1} ( x , y ) \vert ,$$

where T denote the total number of pixels in a frame, fₖ(x,y) denote the pixel intensity value at location (x,y) in the kth frame fₖ. The motion activity curve MA[i] equals the square root of the sum of the squares of the panning, tilting and zooming motion between the ith and i−1th frames. The histogram activity curve HA[i]is computed as follows:

$$H A [ i ] = \frac{1}{M} {\sum }_{m} \frac{{( A H ( i , m ) - H ( i , m ) )}^{2}}{A H ( i , m )} ,$$

where H(i,m),m=1, . . . M is the color histogram of the ith frame, and

$$A H ( i , m ) = \frac{1}{i - n} {\sum }_{k = n}^{i} H ( k , m )$$

is the average histogram.

If the system only determines the cumulative difference curve CFD, it checks if CFD[m−1] exceeds a predetermined threshold, preferably value 15. The system then picks six representative frames at the locations jₖ, k=0, . . . ,5 where

$$C F D [ {j}_{k} ] < \frac{k}{6} C F D [ m - 1 ] \leq C F D [ {j}_{k} + 1 ] .$$

If the system determines the motion activity curve MA, it smoothes the curve using an averaging filter, and thresholds it to convert every number to its binary form, i.e., if MA[i] is larger than the threshold Tₘ, it is set to 1, and otherwise it is set to 0. The system applies morphological closing and opening to smooth this resulting binary curve. The segments of this curve with binary value 1 are found, the segments with significant motion. Within every segment the system picks multiple frames as representative frames depending on the amount of cumulative panning, tilting and zooming motion.

If the system determines the histogram activity curve HA, it, similar to processing the motion activity curve MA, smoothes the curve using an averaging filter, and finds the segments where the curve is monotonically increasing. The last frame in such segment is selected as a representative frame. Since the system uses multiple strategies, the selected representative frames are not always visually different images.

In order to select representative frames that are always different in visual appearance, the system introduces an elimination method. The method orders all representative frames for a shot in ascending order according to their frame numbers and applies two different strategies for eliminating similar images. One strategy uses the histograms. The system starts with the first two representative frames in time and determines their histogram. The second image is eliminated if their cumulative histogram distribution is quite similar, and the consecutive image in the representative frame list is picked for comparison with the first image. If the second image is not eliminated from the representative frame list, it becomes the reference image and the system compares it with the next image in the list.

Another method is object-based. The system segments each representative frame into regions of similar colors. Similarly, it starts with the first and the second image in the list and determines the difference of their segmented versions. Two pixels are considered different if their color labels are not the same. The difference image is then morphologically smoothed to find the overall object motion. If the object motion is not significant, the system eliminates the second frame and checks the difference between the first frame and the next frame in the representative frame list. If the second image is not eliminated from the representative frame list, it becomes the reference image and the system compares it with the next image in the list. Both methods are applied to each frame pair. If either method signals elimination of the second frame, the system removes it from the list. The resulting list of representative frames for each shot comprises key-frames with a priority two.

To stream time-stamped data over a low bitrate and lossy network connection an efficient and robust transfer protocol is needed. Such protocol needs to embed rate control mechanism in order to adjust the data-sending rate to react to the current available bandwidth in a timely efficient manner.

TCP, RDP and RTP have been the most popular transportation protocols used in streaming applications. TCP, as a reliable octet stream based protocol, is obviously not suitable for time-stamped data. Though RDP is typically used in streaming applications, its performance is not good in highly lossy networks. This is because each RDP packet is guaranteed to be transferred to the client, independent of whether it will arrive in time at the client. Such guarantee not only reduces the efficiency, but also may affect the synchronization with other streams and stall the application.

Unlike RDP, RTP lets an application determine the transmission strategy. This is known as Application Layer Framing. Although RTP is quite successful in Multicast applications, it introduces more overheads comparing to other point-to-point protocols. In addition, since RTP is based on a receiver driven retransmission mechanism, it makes packet loss slow to detect and hard to recover in a highly lossy network. Above all, none of these protocols provide a fine dynamic rate control mechanism.

Therefore, an efficient, adaptive, and robust datagram transfer protocol, SCR Streaming Protocol (SSP) is provided.

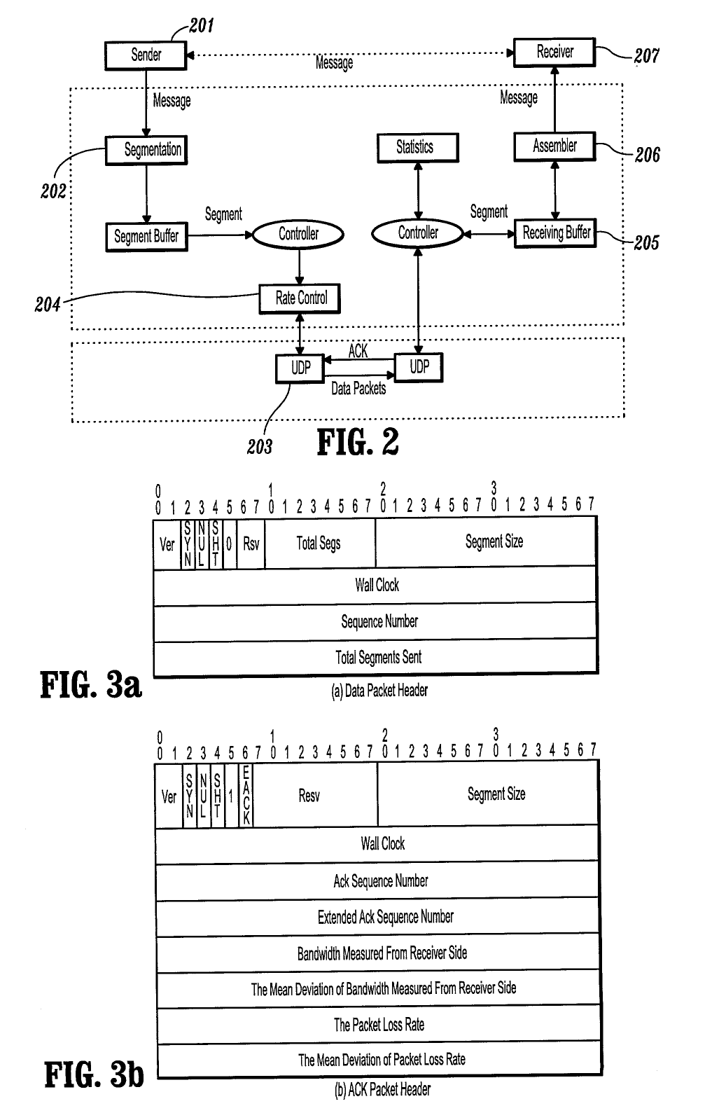

SSP is a point-to-point, uni-directional datagram protocol built on UDP. It provides a message-based interface to application layers. A message is an application data unit (ADU) provided by the application with a size limitation up to 1 Mbytes. A message is marked by the Wall-Clock, which is defined in an application specified unit and used on the client-side for synchronizing data among multiple SSP streams. The architecture of an SSP is shown in FIG. 2.

The sender 201 sends messages to the SSP module. SSP segments each message 202 into small units that can be fitted into a UDP packet 203. Using a rate controller 204, a sender-side SSP module sends UDP packets at a steady rate. A receiver-side SSP module receives the packets and buffered in a receiving queue 205. Packets from the same message are assembled 206 before giving to the receiving application 207.

SSP is a uni-direction protocol. A sender sends data packets to a receiver, and the receiver sends back positive acknowledgement if the packets are correctly received. Types of acknowledgement (ACK) messages include cumulative acknowledgement that acknowledges all packets up to a specified sequence number are received, and extended acknowledgement, which acknowledges only the packet with the specified sequence number is received.

The formats of data packets and ACK packets are shown in FIGS. 3a and 3b respectively.

When each acknowledgement arrives at the sender end, a Round Trip Time (RTT) is calculated. The timeout of sent packet can be calculated by RTT as well as the estimated mean deviation of RTT. After retransmission, the timeout value are backed off by a factor of two and the maximum timeout is set to 10 s.

Before the sender starts to transfer any data, the sender and the receiver synchronize a sequence number. To achieve this, the sender sends out a SYN packet (with the SYN field set) that includes the next sequence number. Upon receiving it, the receiver replies to the sender with a SYNACK packet.

Each time the receiver acknowledges a packet, the play-time is moved forward. Messages with a Wall-Clock stamp earlier than the play-time are obsolete and skipped. In such case, the sender needs to resynchronize with the receiver regarding the next sequence number.

To keep the sender active, the SSP module imposes a minimum sending rate. The dynamic rate control of SSP is based on the packet loss rate reported by the receiver. Two thresholds, θ₁ and θ₂, θ₁>θ₂, are set to determine the current network status. If the packet loss rate LR≦θ₂, the network is light loaded; if the θ₂<LR≦θ₁, the network is heavy loaded; if θ₂<LR, the network is congested.

The actions according to different states are based on an additive increase, multiplicative decrease algorithm:

if network is light loaded, sending rate R=R+R_Inc (R_Inc>0);

if network is heavy loaded, R remains;

if network is congested, R=R*R_Dec (0<R_Dec<1)

if R<minimum sending rate (msr), R=msr

When the SSP module finds the segment buffer is empty, it can notify application layers to send more data. The applications then select key-frames to be transferred. The frame-selecting method includes the following features: each frame selected should be able to arrive at the client before the play-time of client exceeds the Wall-Clock of the frame; as many frames as possible shall be transmitted to the client to take full usage of the current available bandwidth; and key-frames with higher ranks have higher priority for being selected.

To determine if a packet can arrive at the client in time, a Time To Send (TTS) can be determined according to, for example:

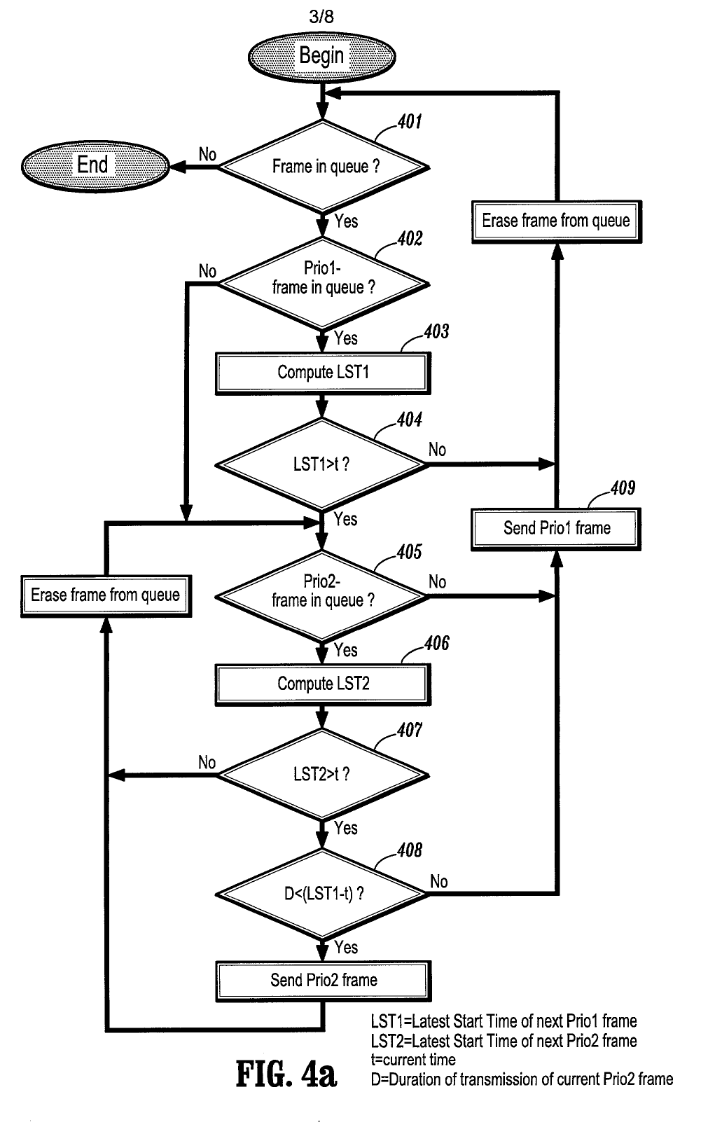

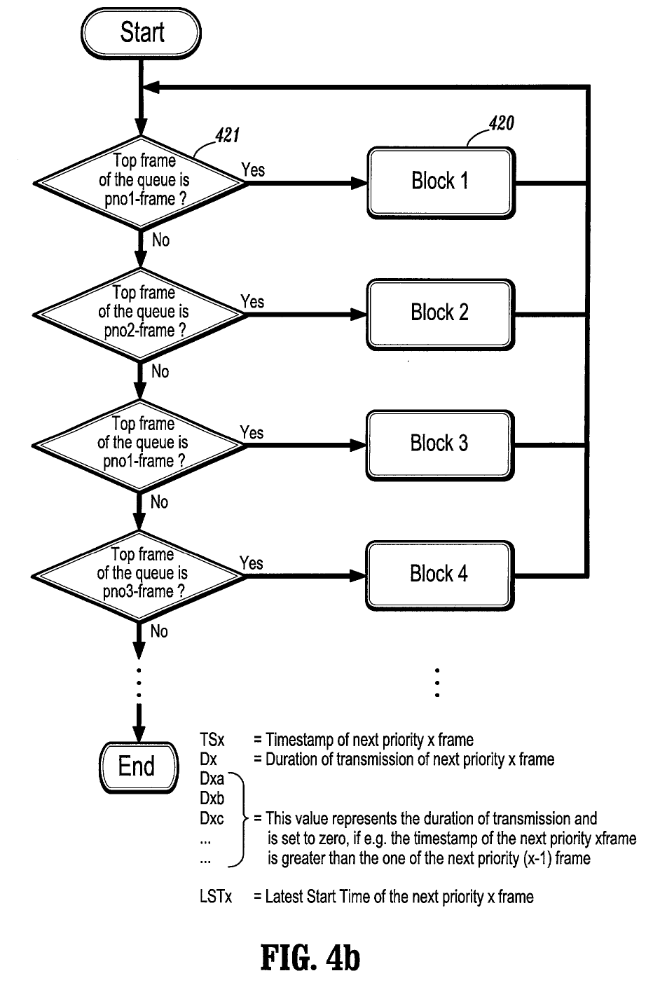

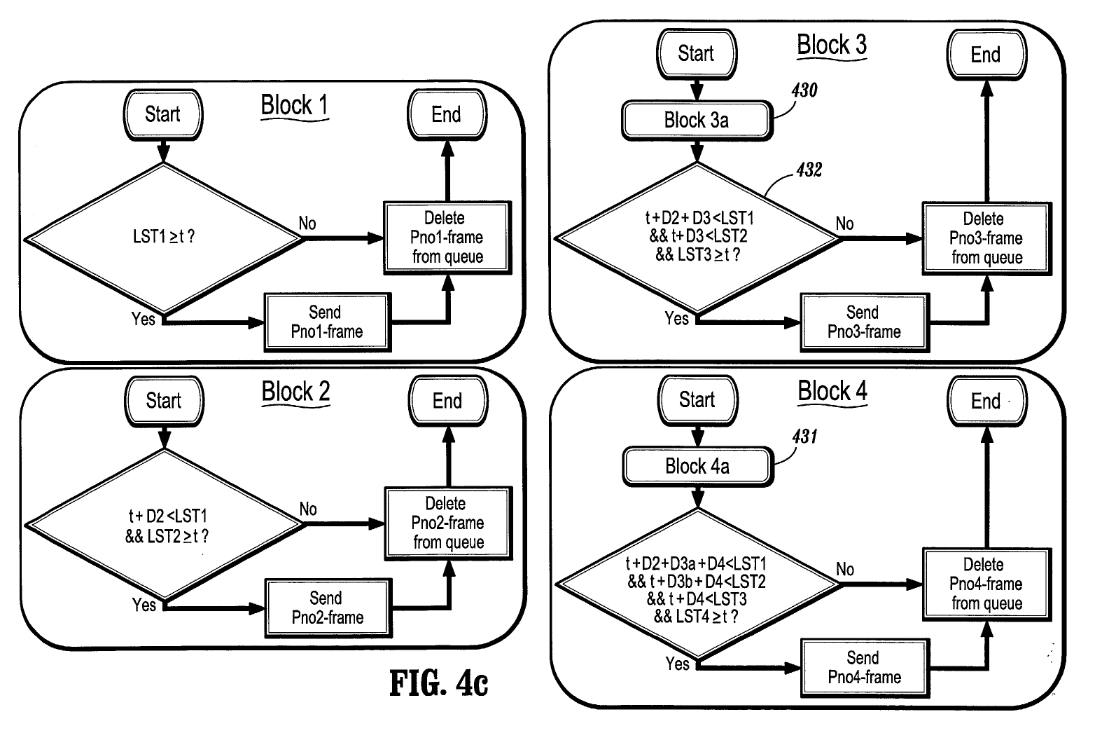

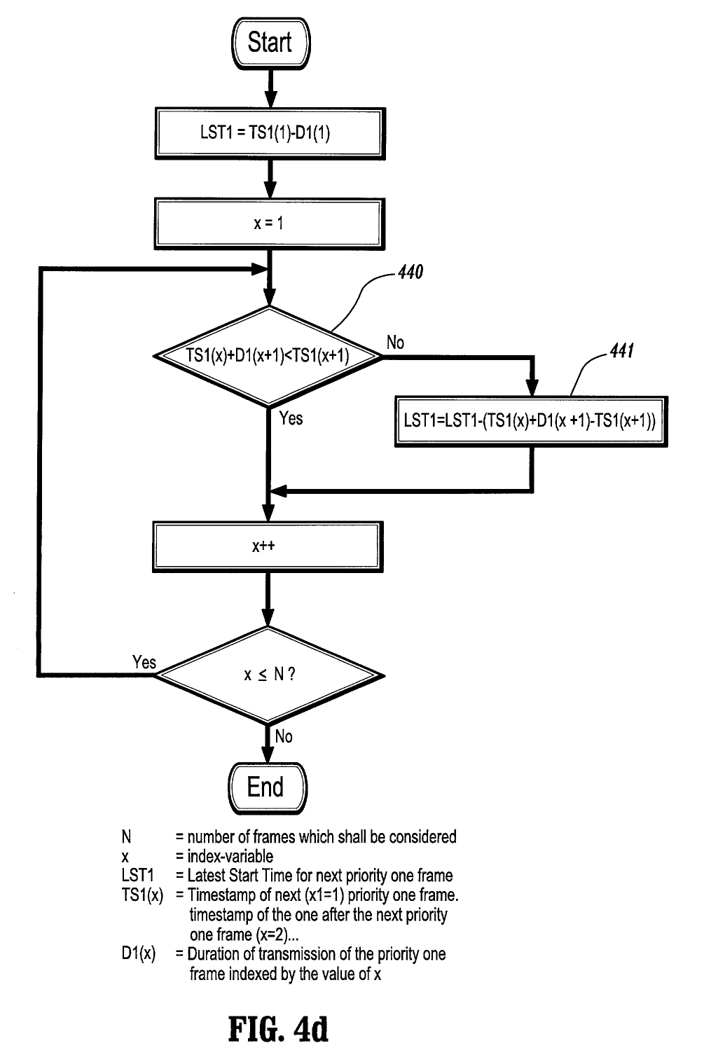

TTS=MessageSize*8/max(min(R,BW),msr) BW is the perceived bandwidth reported by the receiver. The play-time is updated each time an ACK packet is received. Key-frame selection methods are shown as follows and as in FIGS. 4a-d.

for each frame in the queue

if (frame.Wall-Clock<play-time+frame.tts) skip-to-next-frame

fi

tts=frame.tts;

for each frame, which satisfies: frame.Wall-Clock-frame.tts<play-time+tts

select the key-frame whose rank is the highest

send (key-frame );

remove key-frame and all frames before key-frame

rof

rof

According to an embodiment of the present invention, a method for frame streaming using intelligent selection includes, determining if a frame is in a queue 401 and if so, whether that frame is priority one 402. The method determines whether the frame can be transmitted to the client in time, depending on its timestamp, the expected available bandwidth and the current time 403 and 404. The method determines whether the next priority one frame, whose timestamp is greater than the one of the currently considered priority two frame, can still arrive at the client in time after the currently considered priority two frame is sent 405, 406, 407 and 408. Otherwise, the priority one frame is sent 409. The same determination is made for each of the following priority two frames, until either the priority one frames is sent 409 because of its timestamp, or no priority two frames with timestamps smaller than the timestamp of the next priority one frame are left.

According to another embodiment of the present invention, a method can handle more than two priorities. Referring to FIG. 4b, the method can be considered as a plurality of independent blocks, e.g., 420. This, the method is expandable to as many priorities as needed by an application or user. The method uses video as a queue of frames. Within this queue, the frames are sorted according to timestamps. The top frame of a queue is that frame, which has currently the lowest timestamp, compared to all the other frames that are still in the queue, e.g., 421. Every frame is sent to the client, or discarded because it does not fulfill the criteria to be sent. Thus, the size of the queue steadily decreases, until all frames are sent to the connected client, or at least were considered to be sent to the client.

The criteria, whether a frame is sent to a client, or removed from the queue without being sent to the client, are substantially the same as for streaming solution implemented for two priorities.

A frame with priority x is sent to a client if:

the currently considered priority x frame can arrive at the client in time, depending on the frames timestamp, the expected available bandwidth and the current time, and

all next higher priority frame, i.e., the next priority (x−1) frame, the next priority (x−2) frames, . . . , and the next priority 1, frame can still arrive at the client in time, even if the currently considered priority x frame is sent to the client.

The implementation of this decision can be seen in Blocks 1, 2, 3 and 4 of FIG. 4c. The sub-blocks 3a 430 and 4a 431, in Blocks 3 and 4 respectively, are needed for the determination of the value of D2 and in block 4a 431 additionally D3a and D3b. In the case of a priority three frame being considered to be sent next to the client, the transmission time of the next priority two frame, D2, is set to zero, if the next frame in the queue with a higher priority is a priority one and not a priority two frame. In this case, the transmission time D2 of the next priority two frame has not to be taken into account in the comparison t+D2+D3<LST1 432, where Dx is the duration of transmission of the next priority x frame and LSTx is the latest start time of a next priority x frame. The reason for that is that the next priority two frame needs not be sent before the next priority one frame, as this priority two frame has a higher timestamp than the next priority one frame. Therefore, D2 is set to zero. A similar decision is needed, if a priority four frame is considered to be sent, similar to Block 4 and block 4a 431. In this case, the decision considers three higher priorities, namely the priorities three, two and one are taken into account.

Due to the modular structure of the method, it is easily expandable for any number of priorities. However, a general restriction is the amount of computing time needed to select the next frame. The decision, which frame to send, is made on the fly, while the video playback is running. Thus, the computing time should not be too high, as the computation has to done under real time constraints.

According to an embodiment of the present invention, by taking into account at least the next three priority one frames, the case that a group of immediately succeeding priority one frames cannot be sent to a connected client in time, is avoided. Of in this scenario only one priority one frame would have been taken into account, only this one of the group could have been sent to the client in time. The remaining priority one frames of this group would have to be deleted, because they cannot reach the client in time anymore, as too many priority two frames have been sent before instead.

According to an embodiment of the present invention, to handle more than one successive priority one frame, a method uses a value of LST1, which is set to the value of the latest start time of the next priority one frame. Referring to FIG. 4d, the method recursively adjusts the value of LST1, such that all N−1 following priority one frames arrive at the client in time. The basic assumption of the method is that a succeeding priority one frame can be sent to the client once the previous priority one frame has arrived at the client completely. The latest arrival time of a frame can be in the worst case an arrival at the time given by its timestamp. According to this time, the value of LST is determined in general. Therefore, the time between the timestamps of two succeeding priority one frames, P1(x) and P1(x+1), has to be superior to the duration of transmission D1(x+1) of the frame P1(x+1) 440. If this is not the case, the value LST1 is adjusted 441, such that all priority one frames P1(1) . . . P1(x) are sent to the client earlier, and thus, the frame P1(x+1) can arrive at the client in time, too.

This new LST1 can be used in the streaming methods. Thus, even if a group of priority one frames occur in the video, all priority one frames arrive at the client in time, and no lower priority frames are sent instead.

According to another embodiment of the present invention, the method can also be used for a better computation of the LST for other priority classes, as it does not use specific features of priority one frames.

The Content-Sensitive Video Streaming architecture has been developed into two parts: server part and client part.

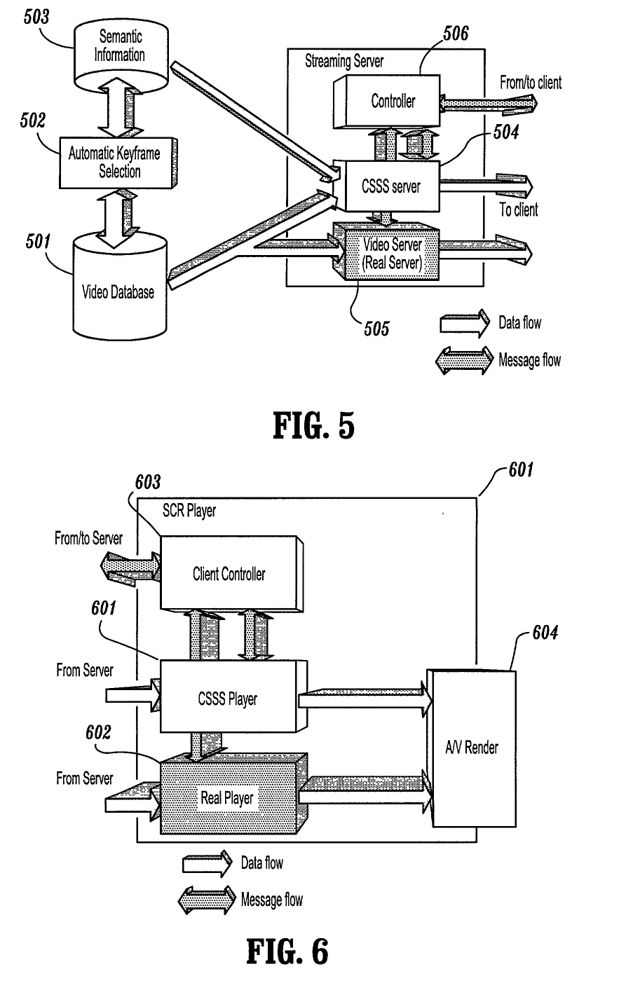

The server-side components can be depicted by FIG. 5. The video files are stored in the video database 501. A key-frame selecting program 502 is running offline, which can automatically scan the video file and select a desirable number of key-frames while preserving as much of the visual content and temporal dynamics in the shot as possible. All these key-frames are ranked into at least two priorities. The first frame of a shot is ranked as priority one, while all other key-frames can be ranked as priority two. The design of a more sophisticated ranking method is contemplated. The extracted semantic information is stored in a separated database 503.

The server controller 506 maintains a control link to the SCR Player 601 via which the player can send request and statistics information. Based on this information, the controller 506 selects proper server that gives out data and controls the servers to provide proper data.

Components of client-side are shown in FIG. 6. Two fully integrated players, 601 and 603, can be included. One can be a Real Player 602 whose responsibility is to play back Real Media streaming video/audio. The other is CSSS player 601, developed by SCR to handle with Content-Sensitive Slide Show stream.

The client controller 603 has multiple functions. It will not only take the input commands of user and translate them into client requests, but also collect statistic information on network connection as well as the playback performance. The client controller 603 maintains a control connection to the server controller 506 via which requests and statistic information are sent.

The media data is displayed to users via A/V Render 604. Moreover, the A/V Render 604 also maintains the synchronization between two media streams (CSSS stream and Real Audio) while playing back the slide show.

Although the technologies of quality of service (QoS) in wired network are well understood, how to provide QoS on wireless (mobile) network can be difficult to implement. Comparing to the wired network, the wireless network has an unstable link quality. Based on radio technology, wireless communication may be more likely affected by the change of environment, e.g., moving in or out of office, passing under a bridge. Moreover, as wireless communication is limited by how far signals carry for given power output, a wireless communication system must use (micro)cells to cover a lager area. While roaming from one cell to another, the mobile user is “handed off” from one base-station to another base-station. As each base-station has different Internet access connection and load, after handoff, the mobile user will likely to have different connection characteristics.

To some extent, the problems of the unstable link quality, namely large variation in the available bandwidth, delivery delay, and losing pattern, are intrinsic in the wireless communication. The management of QoS on wireless network is therefore challenged mostly by these dynamic needs. That results in the need of provision of dynamic QoS management. Rather than providing hard guarantees of QoS, it is likely to accept the changes mobility brings about and hand them to application that would adapt itself to the variation.

A summary of functions in dynamic QoS management is presented in table 1. From the application point of view, in case the underlying layer fails to guarantee the needed QoS parameters, the application must change its behaviors, usually scaling the media down to a low level, and therefore, reducing the resources required. However, if the system improves its ability to provide more resource, the renegotiation should happen again to increase the data transfer rates of the application. Thus, the application could provide media content with higher perceptive quality to end-users.

TABLE 1
Dynamic QoS Management Functions

| Function | Definition | Example Techniques |
|---|---|---|
| Monitoring | Measuring QoS | Monitor actual |
| | actually provided | parameters in |
| | | relation to |
| | | specification, |
| | | usually |
| | | introspective. |
| Policing | Ensuring all parties | Monitor actual |
| | adhere to QoS | parameters in |
| | contract | relation to |
| | | contract, to ensure |
| | | other parties are |
| | | satisfying their |
| | | part. |
| Maintenance | Modification of | The use of filters |
| | parameters by the | to buffer or smooth |
| | system to maintain | stream. QoS aware |
| | QoS. Applications are | routing. |
| | not required to | |
| | modify behavior | |
| Renegotiation | The renegotiation of | Renegotiation of a |
| | a contract | contract is required |
| | | when the maintenance |
| | | functions cannot |
| | | achieve the |
| | | parameters specified |
| | | in the contract, |
| | | usually as a result |
| | | of major changes or |
| | | failures in the |
| | | system. |
| Adaptation | The applications | Application |
| | adapts to changes in | dependent adaptation |
| | the QoS of the | may be needed after |
| | system, possibly | renegotation or if |
| | after renegotation | the QoS management |
| | | fuctions fail to |
| | | maintain the |
| | | specified QoS. |

ReSerVation Protocol (RSVP) [RFC2205] defines a common signaling protocol used in the IntServ QoS mechanism of Internet. RAPI [Internet Draft version 5] suggests an application-programming interface to RSVP aware applications. Besides, KOM RSVP implementation also provides an Object-Oriented Programming interface for RSVP. However, the RSVP and these APIs are designed mainly for the static provision of QoS (reservation and guarantee). In order to support dynamic QoS management aspects, the QoS specification and API can be modified so that applications can supply an acceptable range of QoS parameters rather that the “hard” guarantee requirements.

The present invention can exploit the basic outline of RAPI that controls RSVP daemon with commands and receive asynchronous notification via “upcalls”. The method is also extendable to the original RAPI in following aspects:

Session definition: A traditional RSVP session (data flow) is defined by the triple: (DestAddress, ProtocolId, DstPort). Although RSVP[RFC2205] can provides control for multiple senders (in multicasting), it has no “wildcard” ports. However, in multimedia applications, there always contains multiple streams, which is transferred at separated ports. Although it is possible to multiplexing multiple streams at one single port, it complicates the application design and maintaining as well as reduces the reusable of code. Therefore, the DstPort parameter as shown above can be extended from a single number to a range of ports defined by upper bound and low bound.

Reservation definition: In RSVP, a reservation is made based on flow descriptor. Each flow descriptor consists of a “flow spec” together with a “filter spec”. The flow-spec specifies a desired QoS, which includes two sets of numeric parameters: a Reserve SPEC and a Traffic SPEC. The filter spec, together with a session specification, defines the set of data packets to receive the QoS defined by the flow-spec. While applying dynamic QoS management, instead of specifying a fixed Rspec for a certain filter spec, the method specifies an acceptable range by two Rspecs, for example, Rspec_{low} and Rspec_{high}.

Sender definition: The same story also happens when defining a sender in RSVP session. Instead of a fixed Tspec, an adaptive range (Tspec_{low} and Tspec_{high}) can be specified.

Upcalls: New upcall events can be added to support dynamic provision of QoS. A Renegotiation upcall shall occur each time when the underlying QoS management layer fails to maintain current QoS or inclines to offer improved QoS. The application can accept or reject a renegotiation. If accept, the application shall adapt itself to the new QoS parameters. Otherwise, the QoS management layer shall teardown the session upon a rejection.

Handover Support: During handover, the mobile host moves from one Access point to another one. The handover can be seamless where the changing of the radio connection is not noticeable to the user. However, if the QoS layer fails to do so, a notification shall be issued to application.

The pseudo-code of reservation API is shown below:

| | |
|---|---|
| SessionId createSession( | const NetAddress& destaddr, |
| | uint16 lowPort, |
| | uint16 highPort, |
| | UpcallProcedure, void* |
| | clientData); |

| | |
|---|---|
| void createSender( | SessionId, |
| | const NetAddress& sender, |
| | uint16 port, |
| | const TSpec& lowSpec, |
| | const TSpec& highSpec, |
| | uint8 TTL, const ADSPEC_Object*, |
| | const POLICY_DATA_Object*); |

| | |
|---|---|
| void createReservation( | SessionId, |
| | bool confRequest, |
| | FilterStyle, |
| | const FlowDescriptor& lowSpec, |
| | const FlowDescriptor& highSpec, |
| | const POLICY_DATA_Object* |
| | policyData); |

void. releaseSession( SessionId );

The server controller and client controller cooperate by exchanging information via the control connection. Client's requests, such as presentation selection, VCR commands (for example, play, pause and stop), are sent to the server controller. After the request being processed on the server side, a respond is sent back.

Moreover, it is also the responsibility for the client controller to talk to the reservation API and receive upcalls. Then, the client controller updates the server controller of the network information. The latter may adapt to the change of network condition. A example of a process of client and server cooperation is as follows:

1. The client sends a request for a video

2. The server replies a positive response together with general video information as well as the Quality of Service Specification

3. The client makes the reservation

4. A streaming connection is established between the streaming servers and the players

5. The client initiates a play command to start the streaming of video

6.When the network condition decreases, the client receives a upcall from reservation API

7. The server is notified after receiving a message from the client, and takes proper reactions, e.g. switching between video and slideshow, or scaling the video or slideshow up and down

8.After video is over, the client teardown the reservation and close all connections to the server.

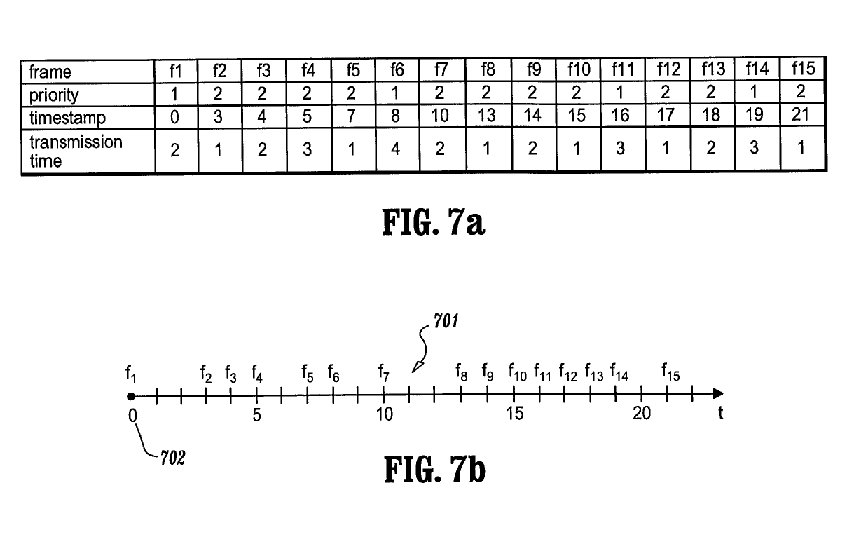

Referring to FIGS. 7a and 7b, a theoretical streaming example according to an embodiment of the present invention. Given a list of fifteen frames with priorities and timestamps assigned to them in FIG. 7a, a constant transfer rate from the server to the client is assumed for convenience. All times are given in dimensionless units of time. Assuming that the client is contacting the server at −2 units of time, the server starts sending frames to the client. Thus, a minimum buffer can be built up on the client side, which enables the client to cope with sudden bandwidth drops during video playback, e.g., at 701. At time 0, 702, the client hits the play button. Thus, the display of the frames according to their timestamp and the starting point, which is 0 units of time in this case, is started.

A content-sensitive video streaming method for very low bitrate and lossy wireless network is provided. According to an embodiment of the present invention, the video frame rate can be reduced while preserving the quality of displayed frame. A content analysis method extracts and ranks all video frames. Frames with higher ranks have higher priority to be sent by the server.

Having described embodiments for streaming videos over connections with narrow bandwidth, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method for frame streaming using intelligent frame selection comprising the steps of:
ranking a plurality of frames according to a plurality of priorities; and
selecting, during a run-time, a frame for transmission over a network to a receiving client, wherein selecting the frame comprises determining a time of transmission, wherein the time of transmission is the time the frame will take to reach the receiving client.

2. The method of claim 1, further comprising the steps of:
determining a priority one frame according to a position in the video; and
determining a priority two frame according to dynamic information in the video.

3. The method of claim 2, wherein dynamic information comprises one of visual effects, camera motion, and object motion.

4. The method of claim 1, wherein frames are ranked according to semantic information.

5. The method of claim 1, wherein semantic information is determined according to a table of contents.

6. The method of claim 1, wherein the step of selecting further comprises the steps of:
determining the frame's rank;
determining a bandwidth over the network; and
determining a current time.

7. The method of claim 1, further comprising the step of determining a round-trip-time.

8. The method of claim 1, wherein the receiving client and a sending client exchange packets comprising a timestamp.

9. The method of claim 1, further comprising the step of determining a time-to-send according to a perceived bandwidth of the network.

10. The method of claim 1, wherein the frame comprises a timestamp.

11. A method for frame streaming using intelligent frame selection comprising the steps of:
determining whether a first frame is in a queue;
determining a first priority of the first frame;
determining whether the first frame can be transmitted to a client;
determining whether a next frame of the first priority, whose timestamp is greater than a currently considered frame of a second priority, can arrive at the client after the currently considered frame of the second priority is sent; and
upon determining that the next frame can arrive, sending the first frame.

12. The method of claim 11, wherein the step of determining whether the first frame can be transmitted depends on a timestamp of the first frame, an expected available bandwidth and a current time.

13. The method of claim 11, further comprising the step of determining, recursively, whether each frame of the second priority can be transmitted to the client, until frames of the first priority are sent according to timestamps, or no frames of the second priority with timestamps smaller than the timestamp of the next frame of the first priority are in the queue.

14. The method of claim 11, wherein, within the queue, frames are sorted according to timestamps.

15. The method of claim 14, wherein the top frame of a queue is that frame, which has currently the lowest timestamp, compared to other frames in the queue.

16. A method for frame streaming using intelligent frame selection comprising the steps of:
sorting a plurality of frames, according to timestamps, within a queue, wherein frames have one of two or more priorities; and
determining whether a top frame of the queue is sent to a client according to a latest start time of the frame.

17. The method of claim 16, wherein the top frame of the queue is that frame, which has currently the lowest timestamp, compared to all the other frames that are still in the queue.

18. The method of claim 16, further comprising the step of adjusting, recursively, a value of a latest start time to the next first priority frame, such that all N−1 following first priority frames arrive at the client.

19. The method of claim 16, wherein the step of determining whether the top frame is to be sent further comprises the step of determining a duration of transmission of the frame.

20. The method of claim 16, wherein the step of determining whether the top frame is to be sent further comprises the step of considering each next frame of a higher priority

21. A method for selecting a ranked frame from a plurality of ranked frames to send to a client comprising the steps of:
determining a rank for a frame of in a queue of frames; and
processing the frame according to its rank and a latest start time of a next frame.

22. The method of claim 21, wherein the step of processing the frame further comprises the steps of:
determining whether the frame can arrive at a client in time, depending on a frame timestamp, an expected available bandwidth and a current time; and
determining whether a next higher priority frame can arrive at the client in time, if the frame is sent to the client.

23. The method of claim 22, wherein the step of determining whether the next higher priority frame can arrive at the client in time is repeated from each queue of frames having a higher priority than the frame.

24. A system for content streaming using intelligent frame selection comprising:
an automatic content analysis module for selecting a key-frame and ranking the key-frame according to a plurality of priorities; and
a streaming server for selecting a frame during a run-time to send to a client according to a time of transmission, wherein the time of transmission is the time the frame will take to reach the receiving client.

25. The system of claim 24, wherein the streaming server comprises:
a sorting module for sorting a plurality of frames, according to timestamps, within a queue, wherein frames have one of three or more priorities; and
a sending module for determining whether the top frame is to be sent to a client according to a latest start time of the frame.

26. The system of claim 24, further comprising the streaming server further comprises:
a controller for maintaining a control link to a client player via which the player can send request and statistics information;
a server for delivering time-stamped frames; and
a video server for delivering an audio track.

27. The system of claim 26, wherein the controller selects a server to transmit frames and controls the servers providing the frames.

28. The system of claim 24, further comprising a client player, wherein the client player comprises:
a client controller accepts input commands and translates the commands into requests; and
at least one player for play back of streaming content. It will not only.

29. The system of claim 28, wherein the client controller collects network connection and playback performance statistical information.

30. The system of claim 28, wherein the client controller maintains a control connection to a server controller through which requests and statistic information are sent.

31. The system of claim 28, wherein the client player further comprises an audio/visual module for displaying content.
